(19) United States
(12) Patent Application Publication
(10) Pub. No.: US 2009/0216757 A1
(43) Pub. Date: Aug. 27, 2009

(54) System and Method for Performing Frictionless Collaboration for Criteria Search

(76) Inventors: Robi Sen, Mclean, VA (US); David Medinets, Fairfax, VA (US)

Correspondence Address: Steven J. Shattil, PO Box 17355, Boulder, CO, 80308, US

(21) Appl. No.: 12/393,718

(22) Filed: Feb. 26, 2009

Related U.S. Application Data
(60) Provisional application No. 61/031,919, filed on Feb. 27, 2008.

(51) Int. Cl. G06F 17/30

(52) U.S. Cl. 707/5; 707/3; 707/E17.014

(57) ABSTRACT

A criteria search performed by a search engine comprises associating each of a plurality of users with at least one knowledge domain, associating a user's query to at least one subject area in the at least one knowledge domain, and generating search results based on the user's query and the at least one subject area. A search engine comprises a plurality of search repositories configured to perform different types of searches and a search component. The search component receives a search query from a user, modifies the query based on one or more knowledge domains that the user is associated with, submits the modified search query to the plurality of search repositories, and receives search results from the plurality of search repositories.

### CLAIM OF PRIORITY UNDER 35 U.S.C. SECTION 119

The present application for patent claims priority to Provisional Application No. 61/031,919 entitled “System and Method for Performing Frictionless Collaboration for Criteria Search,” Attorney Docket No. RS-P02, filed Feb. 27, 2008, assigned to the assignee hereof and hereby expressly incorporated by reference herein.

### BACKGROUND OF THE INVENTION

I. Field of the Invention

The present invention generally relates to retrieving information from a data communication network and, more particularly, to employing information about network users for conditioning search results.

II. Description of the Related Art

A conventional way to cull information on a computer network (e.g., the Internet) is through use of a search engine. A user typically requests relevant information by inputting a query (e.g., search terms or a phrase related to a particular topic) to the search engine, and the search engine attempts to return relevant information in response to the request.

Search engines typically return a number of links to web pages or documents, with a brief description of those links. The simplest and most prevalent way of searching the web is text-based searching, which searches for web pages and documents containing or relating to some or all of the words in a query. Text-based searching over the Web can be notoriously imprecise. Thus, ensuring that the returned pages are relevant to the subject area the user had in mind is a central problem in web searching.

The efficiency of the search process is greatly dependant on the quality of the search. Often a large number of web pages match a user's query. Typically, a presentation of query results are ranked according to a predefined method or criteria, thereby directing a user to what is believed to be the most-relevant information first. Poor-quality queries tend to misdirect the search process, interfere with ranking algorithms, and produce poorer search results. Inefficient Internet search methods tend to slow the data network, occupying web-page servers with requests for irrelevant web pages and clogging data network paths with transmissions of irrelevant web page information.

Determining the correct relevance or importance of a web page to a user can be a difficult task. For one thing, the importance of a web page to the user is inherently subjective and depends on the user's interests, knowledge, and attitudes. Conventional methods of determining relevance are based on matching a user's search terms to terms indexed from web pages. More advanced techniques determine the importance of a web page based on more than the content of the web page. For example, one known method, described in the article entitled “The Anatomy of a Large-Scale Hypertextual Search Engine,” by Sergey Brin and Lawrence Page, assigns a degree of importance to a web page based on the link structure of the web page. However, current public search systems, such as Ask.com, Google, MS Live, etc are predicated on anonymous search, as well as the search being performed in an undefined knowledge domain (i.e. all information in indexed web content).

Prior-art search systems do not adapt search criteria to include information about a user's knowledge domain to facilitate useful search results. As the size of the Internet continues to increase, it becomes increasingly more desirable to have innovative techniques for efficiently searching hyperlinked documents.

### SUMMARY OF THE INVENTION

The described aspects of the invention comprise apparatus, methods, computer readable media and processors operable for performing criteria searches. A criteria search employs user authentication and tracking and recognizes that groups, parties, organizations, or devices within specific knowledge domains will have similar search criteria in response to specific events.

A criteria search may employ any of various well-defined statistical analysis techniques to broker links and communications between disparate individuals or groups within a predetermined knowledge domain. This technique is herein referred to as frictionless collaboration.

In one aspect of the invention, a criteria search comprises monitoring search terms, phrases, results, rankings, and/or other metrics of users' searches and results. A user may be grouped with other users in a predetermined knowledge domain based on the individual's skills, experience, interests, behavior, and/or other predetermined characteristics of the individual. The user can be provided with feedback about what other users within that knowledge domain are searching on, and what terms are popular or similar to what they are searching on.

Some aspects of the invention may employ a statistical-processing means to assist users in finding information deemed valuable by other users within the same knowledge domain. For example, the value of a search result may be subjective—i.e., the search result may be ranked according to how similar users rate it.

In another aspect, a criteria search may be employed for determining a high incident of correlation between various users' search terms within a specific time period, and then notifies a user in a first knowledge domain of users or groups in at least one other knowledge domain who expressed similar interests. These notifications, depending on the usage, may employ email, instant messaging, or any other communication means that allows the parties to collaborate without necessarily being aware of the other party.

Yet another aspect is directed to a search engine that includes a search component and search repositories configured to perform different types of searches. The search component employs information about the user's knowledge domain and a search query from the user to generate a modified search query. The modified search query is input to a number of the search repositories depending on the subject matter pertaining to both the user's query and the user's knowledge domain. The search component receives search results returned from the search repositories and transmits the search results to the user. The search component may modify the search results based on various criteria, including subject matter of the search results and relevance or quality scores of the results.

The above summary of the present invention is not intended to describe each illustrated aspect or every implementation of the present invention. The figures and detailed description that follow more particularly exemplify these aspects.

### BRIEF DESCRIPTION OF THE DRAWINGS

Aspects according to the present invention are understood with reference to the following figures, which are provided to illustrate and not to limit the disclosed aspects.

FIG. 1 is a flowchart of a method for searching documents according to an implementation consistent with the principles of the invention.

FIG. 2 is a flowchart for a criteria-search method in accordance with an aspect of the invention.

FIG. 3 illustrates an alternative method configured to employ criteria search to perform de-conflicting.

FIG. 4 is a flowchart for a criteria-search method according to an implementation consistent with principles of the invention.

FIG. 5 is an exemplary diagram of a network in which concepts consistent with the principles of the invention may be implemented.

FIG. 6 is a diagram illustrating an exemplary implementation of a criteria search engine.

### DETAILED DESCRIPTION

While aspects of the invention are susceptible to various modifications and alternative forms, specific aspects thereof have been shown by way of example in the drawings and are herein described in detail. It should be understood, however, that it is not intended to limit the invention to the particular form disclosed, but rather, the invention is to cover all modifications, equivalents, and alternatives falling within the spirit and scope of the invention as defined by the claims.

Aspects of the present invention are particularly suited to computer-implemented information searching and retrieval applications, such as data network search engine applications, for example. While the present invention is not necessarily limited to such search engine applications, various aspects of the invention may be appreciated through a discussion of various examples using this context.

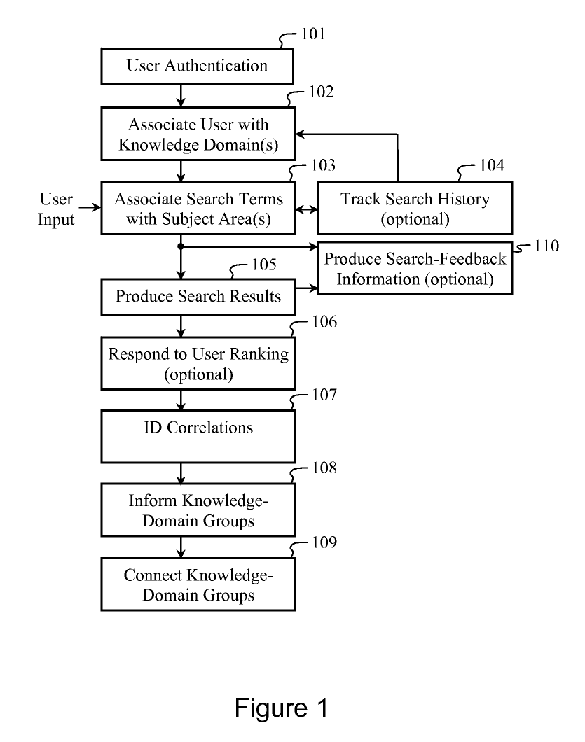

FIG. 1 is a flowchart for a search algorithm performed by systems and methods consistent with the principles of the invention. Search algorithms described herein may comprise executable instructions performed by a computer processor. The term “executable instructions,” as used herein, refers to software applications and/or a piece of code that may be stored in the computer processor as a standalone program and/or file, and/or that may be imbedded within files containing predominantly non-executable data, such as picture files, movie files, text files, and sound files. These executable instructions may be received by and/or stored on and/or executed by a computer processor.

User authentication 101 is performed prior to the user entering a query. The system associates 102 each user to one or more predetermined knowledge domains. The association step 102 may be performed prior to user authentication 101 or following user authentication 101. In some aspects, association 102 may comprise an on-going process as the user queries the system and responds to search results.

A knowledge domain refers to a branch of knowledge, a field of study, an area of expertise, a learned discipline, a subject area, a subject field, or an area of interest. People may be grouped into a particular knowledge domain if they have common interests, skills, expertise, vocation, or training. A person may be associated with one or more knowledge domains using explicit methodologies (e.g., the user directly provides information to the system about interests, expertise, skills, education, etc.), implicit methodologies (e.g., the system analyzes user searches, other online activity, geographical location, connections with other users, public information about the user, social and professional memberships, etc.), or any combination thereof.

A member of a knowledge domain (or user) may comprise an individual, a group of individuals (e.g., a household, a club, a professional organization, a department, etc.), or a computing device (e.g., a computing device communicatively coupled to a network for use by one or more individuals who are members of the knowledge domain, or an automated computing device used by at least one member of a predetermined knowledge domain and configured to collect and transmit data across the network).

The system is configured to respond to user input, such as a query, by associating 103 the query to at least one subject area. Association 103 of search terms in the user's query to a subject area may comprise using a combination of user-specific information, including the user's membership in one or more knowledge domains, the user's search history, and search histories of other users in the same and/or related knowledge domains, to produce search results 105. Search results typically comprise a list of hyperlinks to web pages and/or documents. However, search results are not limited to such forms. For example, search results may comprise retrieved files, database entries, or data or other resources presented in a variety of formats.

In a first aspect, the association of search terms and/or phrases 103 is preconfigured. This association step 103 may remain unchanged (at least for a finite period of time) while the system operates. In a second aspect, the system is configured to update its association of search terms and/or phrases 103 as users perform searches. Such updates may be continuous or periodic. In one aspect of the invention, association 103 may employ the pre-configuration of the first aspect, and then performs the updating in accordance with the second aspect.

In one aspect of the invention, the system may associate 103 search terms and/or phrases in a query to a particular subject area. For example, synonyms and/or phrases having similar meanings may be associated with a given subject area. Furthermore, the system may analyze search results and identify search terms and/or phrases that yield similar search results. The resulting search terms and/or phrases may also be associated with the corresponding subject area. The context of terms used in a phrase may also be used to associate the phrase to a particular subject area.

In another aspect, the association step 103 may suggest alternative queries that extend, shorten, or replace words in the query based on prior queries logged by the system. For example, the system may interpret the meaning of the query based on the user's search history, the user's background or expertise that would suggest the user's interest, and/or queries made by users in the same knowledge domain and/or a similar knowledge domain. In this case, the meaning of the query may be determined subjectively—that is, it is based on predetermined knowledge about the user. For example, the combination of search terms ‘country’ and ‘western,’ when used together, would likely pertain to a different subject area for a geographer than for a musician. Thus, the system may search the subject of maps for the geographer, whereas it would search the subject of music for the musician even though identical search terms were entered.

The system may optionally track 104 a user's search history. In one aspect, the system may analyze a user's prior search history, and upon identifying the user's focus on one or more particular subject areas, it may confine subsequent searches to those subject areas. In the step of generating the search results 105, the system may provide the user with an option of searching in one or more selectable subject areas. For example, the term “driver” may yield results pertaining to the subject areas of golf, software, and limousines. The system may categorize search results with respect to different selectable subject areas, and then solicit additional user input in order to update the search results.

The tracking step 104 may further be used to update the association step 102 in which users are associated with knowledge domains. Optionally, the tracking step 104 may be used to update the association step 103 in which search terms are associated with subject areas.

In an optional response 106 to user rankings, a history of user responses to search results may be used to rank future search results. The system may rank future search results in step 105 with respect to how users ranked previous search results. The rankings may be implicit (e.g., number of user page views or document downloads), explicit (e.g., user-input evaluations), or a combination thereof. The system may rank search results with respect to feedback from members of all knowledge bases, members of related knowledge bases, or members of one particular knowledge base. In alternative aspects, the system may employ additional or alternative metrics related to user search data in order to rank search results.

In an optional search-feedback step 110, the system is responsive to a user's query and provides the user with search-feedback information, such as similar search terms and/or phrases used to search a particular subject of interest. The search-feedback information may comprise related search terms and/or phrases employed by other members of the user's knowledge base. The search-feedback information may comprise related search terms and/or phrases employed by members of other knowledge bases, and it may disclose to the user which search terms and/or phrases about the subject area are most popular within the user's knowledge base, as well as other knowledge bases.

In one aspect, the system may be configured to provide search feedback 110 to a user about search data that is specific to a particular knowledge domain (e.g., searches performed by other members of the user's knowledge domain). For example, the system may tabulate search terms, subject areas, and/or search results that are popular within the user's knowledge domain. The search data may be indexed, grouped, or otherwise arranged with respect to time. Similarly, search data that is particular to other knowledge domains may be collected and presented to the user. In a related aspect, the search data may comprise information about which knowledge-domain groups have exhibited interest in a particular subject.

The system may track searches performed by members of different knowledge domains, and it may be configured to identify 107 correlations of interest in subject areas by members of different knowledge domains. For example, the system may identify common or related search terms. Thus, the system may identify correlations in search behaviors of different users. In the event that a correlation occurs within a predetermined time interval, the system informs 108 at least one user in at least one of the knowledge domains about the correlation. The system may optionally distribute 109 contact information for each group searching a particular subject.

In a related aspect, the search-feedback step 110 allows a user to direct the system to monitor activity relating to searches in a particular subject area and notify the user when a predetermined search-activity event occurs (e.g., a search performed by a particular user, a search performed by any user of a particular group or knowledge domain, when the number of searches in the subject area exceeds a predetermined limit in a given time frame, when a predetermined correlation of searches occurs between users in different knowledge domains, etc.).

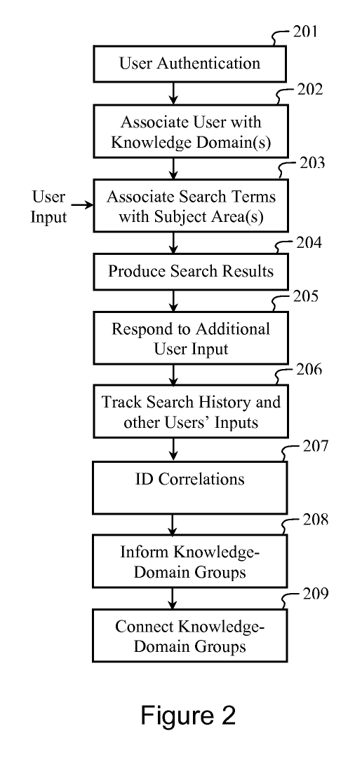

FIG. 2 is a flow chart for a criteria-search method in accordance with an aspect of the invention. A method in accordance with this aspect may be employed for identifying, tracking, and responding to an outbreak of a disease, such as West Nile Virus. For example, a method of the invention may facilitate data aggregation and improve situational awareness for groups responding to the outbreak of a disease and groups capable of controlling conditions that affect the spread of the disease.

Following user authentication 201 and user association 202, an epidemiologist enters a search query, such as “West Nile Virus.” The search system associates the user with at least one medical knowledge domain and responds by associating 203 the search terms with subjects in the at least one medical knowledge domain. For example, search results 204 pertaining to the subject of epidemiology may be displayed. The system may respond with search results 204 that include the following selectable categories: Symptoms, Testing, Causes, Transmission, Treatment, Prevention, and Research. The system may record 205 further user inputs, such as which sub-topics are selected and which documents are viewed.

As the system tracks 206 search histories of other users, it may identify other knowledge-domain/subject-area combinations that yield similar search results (e.g., other doctors reviewing similar medical data, clinics ordering testing kits and medications, municipal governments searching for ways to remove standing water or control mosquitoes, the general population entering search terms correlating with the symptoms of West Nile Virus). Accordingly, the system may be configured to identify correlations 207 between searches performed by other users and/or search results that are returned. In one aspect, an organization, such as the Center for Disease Control may utilize data visualization or machine learning to identify patterns in search data and predict the spread of the disease. Furthermore, knowledge-domain groups (such as medical clinics and municipal governments may be informed 208 of certain trends or threats, and different knowledge-domain groups may be communicatively coupled 209 together.

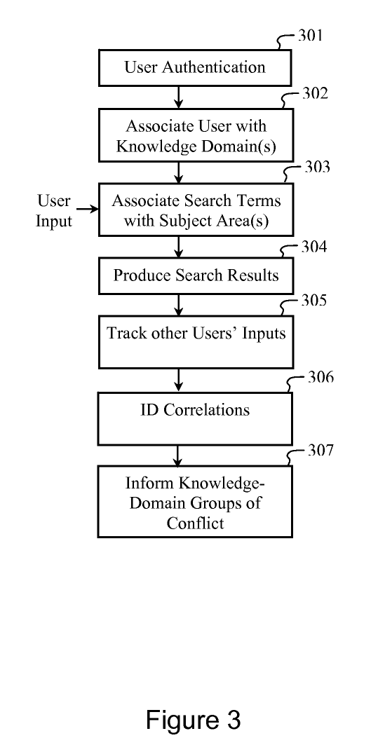

FIG. 3 illustrates an alternative method aspect of the invention configured to employ criteria search for de-conflicting. When multiple law-enforcement agencies target the same suspects, conflicts may arise if the agencies are not aware of each other's activities. De-conflicting provides the agencies with knowledge of each other's operations in order to avoid such conflicts.

In one aspect of the invention, a user associated 302 with a first law enforcement agency (e.g., the Los Angeles Police Department (LAPD)) submits a query about a particular individual believed to be involved in criminal activity being investigated by that agency. The system produces 304 search results corresponding to the query and the related criminal investigation, and provides information linking the individual to a gang. The system also tracks 305 other users' inputs, including queries made from other law-enforcement agencies. For example, the system may identify correlations 306 between the LAPD's investigation and intelligence-gathering operations conducted by the Drug Enforcement Administration (DEA) that could lead both law-enforcement agencies to the same gang. Both the LAPD and the DEA are informed 307 of the correlation. This enables the DEA to inform the LAPD that it has undercover agents investigating drug-trafficking activities of the gang so the LAPD does not interfere with the investigation or inadvertently harm the undercover agents.

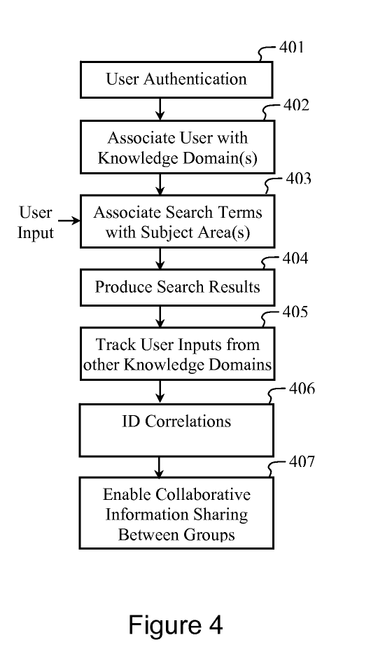

FIG. 4 illustrates a method that may be performed with respect to another aspect of the invention. In counter-terrorism, disparate sources may have pieces of information that, only when taken together, define a clear and present danger. Thus, aspects of the invention may be configured to coordinate and combine information-gathering operations between intelligence, law-enforcement, and counter-terrorism organizations.

Following user authentication 401 and associating 402 each user with at least one corresponding knowledge domain, a system in accordance with one aspect of the invention receives user inputs (e.g., queries) and associates 403 the inputs with subject areas corresponding to each user's knowledge domain. Corresponding search results are generated 404. User inputs and/or search results are tracked 405. Correlations between search requests from a plurality of knowledge domains and/or the corresponding search results are identified 406. The system may initiate collaborative information sharing 407, such as by notifying users of these correlations.

In one aspect of the invention, a transportation company queries a drivers' license database to determine if a new employee has a commercial drivers license. Information linking the first subject's name to the transportation company is stored by the system as part of the tracking step 405. Further information about the first subject's association with a second subject in suspected criminal activity is recorded from recent queries and stored in a law-enforcement agency's database. The tracking step 405 may track the second subject's purchases, including purchases of supplies that could be used to construct an explosive device.

A federal agency investigating a suspicious explosion involving one of the transportation company's vehicles may input a query comprising the name of the transportation company and the components of the device used to detonate the vehicle. The system produces search results 404 and then identifies correlations 406 between the search terms and/or the search results with search terms and/or the search results corresponding to other knowledge domains. Thus, the system is able to display a sequence of related events derived from disparate sources of information.

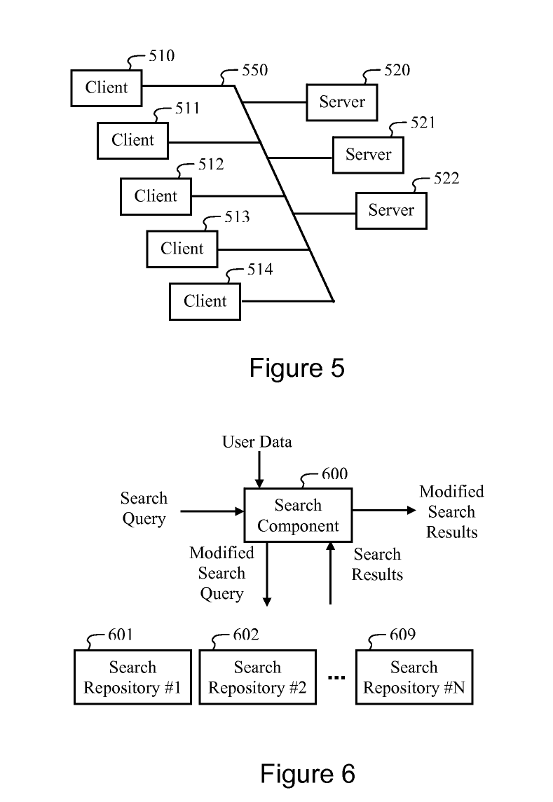

FIG. 5 is an exemplary diagram of a network in which systems and methods consistent with the principles of the invention may be implemented. Multiple clients 510-514 may be connected to multiple servers 520-522 via a communications network 550. The communications network 550 may include any combination of a local area network (LAN), a wide area network (WAN), a telephone network, such as the Public Switched Telephone Network (PSTN), an intranet, the Internet, a memory device, or any other type of network. Five clients 510-514 and three servers 520-522 have been illustrated as connected to the network 550 for simplicity. In practice, there may be more or fewer clients and servers. Also, in some instances, a client may perform the functions of a server and a server may perform the functions of a client.

Clients 510-514 may include client entities. An entity may be defined as a device, such as a wireless telephone, a personal computer, a personal digital assistant (PDA), a lap top, or another type of computation or communication device, a thread or process running on one of these devices, and/or an object executable by one of these devices. Servers 520-522 may include server entities configured to gather, process, search, and/or maintain documents in a manner consistent with the principles of the invention. Clients 510-514 and servers 520-522 may connect to network 550 via wired, wireless, and/or optical connections.

In an implementation consistent with the principles of the invention, the server 520 may optionally include a search engine usable by the clients 510-514. Server 520 may crawl documents (e.g., web pages) and store information associated with these documents in a repository of crawled documents. Servers 521 and 522 may store or maintain documents that may be crawled by server 520. While servers 520-522 are shown as separate entities, it may be possible for one or more of servers 520-522 to perform one or more of the functions of another one or more of servers 520-522. For example, it may be possible that two or more of servers 520-522 are implemented as a single server. It may also be possible that a single one of servers 520-522 is implemented as multiple, possibly distributed, devices.

FIG. 6 is a diagram illustrating an exemplary implementation of a search engine according to one aspect of the invention. The search engine may include a search component 600 and a set of search repositories 601-609. In general, search component 600 may submit search queries to one or more of the search repositories 601-609 and receive search results back from search repositories 601-609.

The search repositories 601-609 may each include an indexed set of data of a particular type or category. For example, search repository 601 may include search data pertaining to the subject of golf. Search repository 602 may include search data pertaining to the subject of software. Search repository 609 may include search data pertaining to the subject of limousines. Search data may include an index of businesses, web pages, documents, maps, reviews, or other information that is associated with the search repository's category. Search data may include search results generated from previous queries made by users associated with predetermined knowledge domains. Each search repository 601-609 may return search results, such as links to relevant documents that correspond to the search query input to the search repositories 601-609.

The search repositories 601-609 may also be associated with appropriate hardware/software to perform a search of the data in the repository. For example, search data repository 601 may include one or more computing devices, such as the servers 520-522, configured to receive a search query from search component 600 and return search results in response to the search query. The search results may additionally include relevance or quality scores associated with the search results. These scores may be used by search component 600 to obtain a confidence score that measures how confident the search repository is in the search results. A confidence score for a particular set of search results may be calculated, for example, as the sum or average of the relevance scores of a certain number of the search results (e.g., as an average relevance score of the five most relevant search results). As another example, the confidence score for a particular set of search results may be calculated as the highest (i.e., most relevant) normalized relevance score in the set of search results. In some implementations, repositories 601-609 may be implemented as a single repository that contains multiple types of search data.

In operation, search component 600 receives a search query from a user, such as from a user of a client 510-514, and user data associating the user to at least one knowledge domain. The search component 600 may modify the search query based on any number of criteria, including (but not limited to) the user's knowledge domain(s). Furthermore, the search component 600 may select one or more of the search repositories 601-609 related to both the search query and the user's knowledge domain(s). Search results generated by the selected search repositories 601-609 are returned to the search component 600. The search component 600 may modify the search results, such as to filter or categorize the search results, and return the modified search results to the user.

Method aspects of the invention may be performed by a processor configured for executing software instructions contained in a computer-readable medium, such as a memory. Computer programs (i.e., software and/or firmware) implementing methods in accordance with aspects of this invention may reside on a distribution medium, such as a SIM card, a USB memory interface, or other computer-readable memory adapted for interfacing with the processor. From there, they will often be copied to a hard disk or a similar intermediate storage medium. When the programs are to be run, they may be loaded either from their distribution medium or their intermediate storage medium into the execution memory of a digital computer system (e.g. a microprocessor) to act in accordance with the method of this invention.

The term “computer-readable medium” encompasses distribution media, intermediate storage media, execution memory of a computer, and any other medium or device capable of storing for later reading by a digital computer system a computer program implementing the method of this invention. A computer-readable medium may be defined as a physical or logical memory device. The software instructions may be read into memory from another computer-readable medium, such as data storage device, or from another device via a communication interface. Alternatively, hardwired circuitry may be used in place of, or in combination with software instructions to implement processes consistent with the principles of the invention. Thus, implementations consistent with the principles of the invention are not limited to any specific combination of hardware circuitry and software.

Various digital computer system configurations can be employed to perform the method aspects of this invention, and to the extent that a particular system configuration is capable of performing the methods corresponding to aspects of this invention, it is equivalent to the representative system aspects disclosed herein.

Accordingly, the present invention is not to be necessarily limited to the particular examples described above, but is intended to cover all aspects of the invention as fairly set out in the attached claims. For instance, while a method for criteria search of a data network search engine application is illustrated, other techniques for criteria search in computer-implemented applications can benefit from the above mentioned teachings. Various modifications, equivalent processes, as well as numerous structures to which the present invention may be applicable will be readily apparent to those of skill in the art to which the present invention is directed upon review of the present specification. The claims are intended to cover such modifications and devices.

1. A method comprising:
associating each of a plurality of users to at least one knowledge domain;
associating a user's query to at least one subject area corresponding to the at least one knowledge domain; and
generating search results based on the user's query and the at least one subject area.

2. The method recited in claim 1, wherein associating each of the plurality of users comprises an on-going association process as users query the system and respond to search results.

3. The method recited in claim 1, wherein associating each of the plurality of users comprises employing a combination of explicit methodologies and implicit methodologies.

4. The method recited in claim 1, wherein the at least one knowledge domain comprises at least one of a branch of knowledge, a field of study, an area of expertise, a learned discipline, a subject area, a subject field, and an area of interest.

5. The method recited in claim 1, wherein associating the user's query comprises employing a combination of user-specific information, the user's search history, and search histories of other users for selecting the at least one subject area.

6. The method recited in claim 1, wherein generating the search results comprises performing a combination of filtering the search results based on the at least one subject area, categorizing the search results relative to a plurality of subject categories, and ranking the search results.

7. The method recited in claim 1, further comprising employing user inputs to the search results to update generating the search results.

8. The method recited in claim 1, further comprising providing the user with search-feedback information.

9. The method recited in claim 1, further comprising identifying correlations in search behaviors of different users.

10. The method recited in claim 1, further comprising providing for communicatively coupling users that exhibit similar search behaviors.

11. A digital computer system configured to perform the method recited in claim 1.

12. A machine-readable medium comprising instructions encoded thereon and executable to:
associating each of a plurality of users to at least one knowledge domain;
associating a user's query to at least one subject area in the at least one knowledge domain; and
generating search results based on the user's query and the at least one subject area.

13. The machine-readable medium recited in claim 12, further comprising instructions for employing user inputs to the search results to update generating the search results.

14. The machine-readable medium recited in claim 12, further comprising instructions for providing the user with search-feedback information.

15. The machine-readable medium recited in claim 12, further comprising instructions for identifying correlations in search behaviors of different users.

16. The machine-readable medium recited in claim 12, further comprising instructions for communicatively coupling users that exhibit similar search behaviors.

17. A search engine comprising:
a plurality of search repositories configured to perform different types of searches; and
a search component configured to:
receive a search query from a user;
modify the search query based on one or more knowledge domains that the user is associated with;
submit the modified search query to the plurality of search repositories; and
receive search results from the plurality of search repositories.

18. The search engine recited in claim 17, wherein the search component is further configured to transmit search results to the user based on the search results returned from the plurality of search repositories.

19. A computer-readable medium containing processing instructions executable by one or more processors, the computer-readable medium comprising:
instructions for receiving a search query from a user;
instructions for modifying the search query based on one or more knowledge domains that the user is associated with;
instructions for submitting the modified search query to the plurality of search repositories; and
instructions for receiving search results from the plurality of search repositories.

20. The computer-readable medium recited in claim 19, further comprising instructions for transmitting search results to the user based on the search results returned from the plurality of search repositories.
